(19) United States
(12) Patent Application Publication
(10) Pub. No.: US 2026/0192785 A1
(43) Pub. Date: Jul. 9, 2026

(54) ROTATION ANGLE DETECTION DEVICE

(71) Applicant: DENSO CORPORATION, Kariya-city (JP)

(72) Inventor: Yasuyuki NAKAO, Kariya-city (JP)

(21) Appl. No.: 19/554,273

(22) Filed: Mar. 2, 2026

Related U.S. Application Data
(63) Continuation of application No. PCT/JP2024/032729, filed on Sep. 12, 2024.

(30) Foreign Application Priority Data
Oct. 4, 2023 (JP) 2023-172949

(51) Int. Cl. B60T 7/04; G01B 7/30; G01D 5/14

(52) U.S. Cl. CPC B60T 7/042; G01B 7/30; G01D 5/145; B60T 2220/04

(57) ABSTRACT

A rotation angle detection device includes a magnetic circuit having a first magnet, a second magnet, a first yoke and a second yoke, and a magnetic detection unit being fixed to a support body so that a magnetic detection element is positioned on an axis of rotation of the rotating body. A direction in which an imaginary line connecting the center of the first magnet and the center of the second magnet extends is defined as a first direction, and a direction in which the axis extends and the direction perpendicular to the first direction are defined as a second direction. The first yoke and the second yoke are arranged opposite to each other in the second direction with the axis interposed therebetween. A first magnet distance and a second magnet distance are both greater than or equal to a yoke inner wall distance.

### CROSS REFERENCE TO RELATED APPLICATIONS

The present application is a continuation application of International Patent Application No. PCT/JP2024/032729 filed on September 12, 2024, which designated the U.S. and claims the benefit of priority from Japanese Patent Application No. 2023-172949 filed on October 4, 2023, the entire disclosure of the above application is incorporated herein by reference.

### TECHNICAL FIELD

The present disclosure relates to a rotation angle detection device.

### BACKGROUND

The rotation angle detection device is used in, for example, an electronic throttle of an automobile.

### SUMMARY

An object of the present disclosure is to provide a rotation angle detection device capable of improving the detection accuracy of a rotation angle, and a brake pedal device including the same.

According to one aspect of the present disclosure, a rotation angle detection device for detecting a rotation angle of a rotating body provided rotatably with respect to a support body includes:

a magnetic circuit fixed to the rotating body, the magnetic circuit having a first magnet and a second magnet arranged opposite each other across a rotation axis of the rotating body and having the same magnetization direction, and a first yoke and a second yoke connecting the same poles of the first magnet and the second magnet; and

a magnetic detection unit having a magnetic detection element configured to output an electric signal according to a magnetic field in an inner region of the magnetic circuit, the magnetic detection element being fixed to the support body so that the magnetic detection element is positioned on the axis.

When a direction in which an imaginary line connecting a center of the first magnet and a center of the second magnet extends is defined as a first direction, and a direction in which the axis extends and which is perpendicular to the first direction is defined as a second direction,

the first yoke and the second yoke are disposed opposite to each other in the second direction across the axis.

A distance between a portion of the first yoke facing a north pole of the first magnet and a portion of the second yoke facing a south pole of the first magnet and a distance between a portion of the first yoke facing a north pole of the second magnet and a portion of a second yoke facing a south pole of the second magnet are both greater than or equal to a distance between a surface of the first yoke facing the second yoke between the first magnet and the second magnet and a surface of the second yoke facing the first yoke between the first magnet and the second magnet.

According to another aspect of the present disclosure, a brake pedal device mounted on a vehicle includes:

a support body fixed to a vehicle body;

a shaft member provided on the support portion;

a brake pedal provided rotatably within a predetermined angle range around an axis of the shaft member relative to the support body; and

a rotation angle detection device according to one aspect of the present disclosure, which detects a rotation angle of the shaft member as the rotating body or the brake pedal as the rotating body relative to the support body.

### BRIEF DESCRIPTION OF THE DRAWINGS

FIG. 1 is a schematic diagram of a brake-by-wire system including a brake pedal device in which a rotation angle detection device according to a first embodiment is used;

FIG. 2 is a cross-sectional view of the brake pedal device taken along a plane perpendicular to an axis of a shaft member;

FIG. 3 is a cross-sectional view taken along a line III-III in FIGS. 1 and 2;

FIG. 4 is a structural diagram of the rotational angle detection device according to the first embodiment, in the cross-sectional view taken along a line IV-IV of FIG. 3;

FIG. 5 is an explanatory diagram for explaining one-axis detection in the rotation angle detection device;

FIG. 6 is an explanatory diagram for explaining two-axis detection in the rotation angle detection device;

FIG. 7 is a configuration diagram of a rotation angle detection device according to a second embodiment;

FIG. 8 is a configuration diagram of a rotation angle detection device according to a third embodiment;

FIG. 9 is a configuration diagram of a rotation angle detection device according to a fourth embodiment; and

FIG. 10 is a configuration diagram of a rotation angle detection device of a comparative example.

### DETAILED DESCRIPTION

The rotation angle detection device described in an assumable example is used in, for example, an electronic throttle of an automobile. The electronic throttle has a configuration in which a shaft member fixed to a throttle valve is rotatable relative to a housing. The rotation angle detection device includes a magnetic circuit provided on the shaft member and a magnetic detection unit provided on the housing so as to be positioned on the axis of rotation of the shaft member, and detects the rotation angle of the shaft member relative to the housing.

The magnetic circuit provided in the rotation angle detection device has two magnets and two yokes. The two magnets are arranged opposite each other across the axis of rotation of the shaft member, and are magnetized in the same direction. One of the two yokes connects the north poles of the two magnets together, and the other yoke connects the south poles of the two magnets together.

One of the yokes has a first concave curved surface and a second concave curved surface in the vicinity of each of the two magnets, extending from the magnet side toward a center portion and away from an imaginary line connecting the centers of the two magnets. One of the yokes has a parallel portion formed parallel to the imaginary line in the center portion between the first concave curved surface and the second concave curved surface.

The other yoke also has a third concave curved surface and a fourth concave curved surface in the vicinity of the two magnets, respectively, which extend from the magnet side toward the center portion and away from the imaginary line. The other yoke also has a parallel portion formed parallel to the imaginary line in the center portion between the third concave curved surface and the fourth concave curved surface.

With this configuration, when the magnetic circuit rotates together with the shaft member, the direction of the magnetic field passing through the magnetic detection unit changes, and the magnetic detection unit outputs an electric signal according to the direction of the magnetic field.

However, the two yokes provided in the rotation angle detection device have first to fourth concave curved surfaces in the vicinity of the magnet. Here, the magnetic field emitted into space from the surface of the yoke facing the axis (hereinafter referred to as the "inner wall surface of the yoke") is emitted perpendicular to the inner wall surface of the yoke. Therefore, part of the magnetic field emitted from the first to fourth concave curved surfaces of the yoke passes through the vicinity of the axis in an inner region of the magnetic circuit. Therefore, in the inner region of the magnetic circuit including the axis and its vicinity, a range of parallel magnetic fields where only parallel components of the magnetic field exist without being affected by the magnetic fields emitted from the first to fourth concave curved surfaces becomes small. Therefore, in this rotation angle detection device, when the housing and the shaft member become misaligned due to clearance or the like caused by the rotational movement of the housing and the shaft member, and as a result the magnetic detection unit moves from its position on the axis to outside the parallel magnetic field range, there is a risk that the detection accuracy of the rotation angle will decrease.

An object of the present disclosure is to provide a rotation angle detection device capable of improving the detection accuracy of a rotation angle, and a brake pedal device including the same.

According to one aspect of the present disclosure, a rotation angle detection device for detecting a rotation angle of a rotating body provided rotatably with respect to a support body includes:

a magnetic circuit fixed to the rotating body, the magnetic circuit having a first magnet and a second magnet arranged opposite each other across a rotation axis of the rotating body and having the same magnetization direction, and a first yoke and a second yoke connecting the same poles of the first magnet and the second magnet; and

a magnetic detection unit having a magnetic detection element configured to output an electric signal according to a magnetic field in an inner region of the magnetic circuit, the magnetic detection element being fixed to the support body so that the magnetic detection element is positioned on the axis.

When a direction in which an imaginary line connecting a center of the first magnet and a center of the second magnet extends is defined as a first direction, and a direction in which the axis extends and which is perpendicular to the first direction is defined as a second direction,

the first yoke and the second yoke are disposed opposite to each other in the second direction across the axis.

A distance between a portion of the first yoke facing a north pole of the first magnet and a portion of the second yoke facing a south pole of the first magnet and a distance between a portion of the first yoke facing a north pole of the second magnet and a portion of a second yoke facing a south pole of the second magnet are both greater than or equal to a distance between a surface of the first yoke facing the second yoke between the first magnet and the second magnet and a surface of the second yoke facing the first yoke between the first magnet and the second magnet.

In the present disclosure, "same" means substantially the same in light of the intent of this disclosure, and includes not only complete sameness but also slight non-identity due to, for example, manufacturing tolerances. In the following description, the first yoke and the second yoke may be collectively referred to simply as "yokes," and the first magnet and the second magnet may be collectively referred to simply as "magnets."

According to the above configuration, the magnetic field emitted from the portion of the yoke near the magnet and passing through the inner region of the magnetic circuit does not affect the magnetic field emitted from the portion of the yoke other than the portion near the magnet (i.e., the central portion of the yoke) and passing through the inner region of the magnetic circuit. This allows the range of the parallel magnetic field to be increased in the inner region of the magnetic circuit including the axis and the vicinity of the axis. Therefore, even if the magnetic detection unit moves from the axis due to a positional misalignment between the support body and the rotating body, the direction of the magnetic field passing through the magnetic detection unit is prevented from changing due to the movement. Therefore, the rotation angle detection device can improve the detection accuracy of the rotation angle of the rotating body relative to the support body.

According to another aspect of the present disclosure, a brake pedal device mounted on a vehicle includes:

a support body fixed to a vehicle body;

a shaft member provided on the support portion;

a brake pedal provided rotatably within a predetermined angle range around an axis of the shaft member relative to the support body; and

a rotation angle detection device according to one aspect of the present disclosure, which detects a rotation angle of the shaft member as the rotating body or the brake pedal as the rotating body relative to the support body.

According to this configuration, when the brake pedal device erroneously detects an angle at which the brake pedal is pressed heavily when the driver applies a small amount of pressure to the brake pedal, this could result in sudden deceleration unintended by the driver. Furthermore, when the brake pedal device erroneously detects the angle at which the brake pedal is depressed when the driver is not applying any pressure to the brake pedal, there is a risk that the brakes will be applied unintentionally while the vehicle is moving. Therefore, the rotation angle detection device used in the brake pedal device is required to detect the rotation angle of the rotating body relative to the support body with high accuracy.

On the other hand, in the brake pedal device, since the shaft member or brake pedal as the rotating body rotates relative to the support body, a clearance is provided between the support body and the rotating body, and therefore, a positional misalignment (i.e., axial misalignment) may occur between the support body and the rotating body. Due to these circumstances, the rotation angle detection device used in the brake pedal device is required to be able to detect angles with high accuracy even when the support body and the rotating body are misaligned. In response to such requirements specific to the brake pedal device, the rotation angle detection device can detect the rotation angle of the rotating body or relative to the support body with high accuracy even if the magnetic detection unit moves from the axis due to a positional misalignment between the support body and the rotating body.

Hereinafter, embodiments of the present disclosure will be described with reference to the drawings. In the following embodiments, the same or equivalent parts are denoted by the same reference numerals as each other, and explanations will be provided to the same reference numerals.

### First Embodiment:

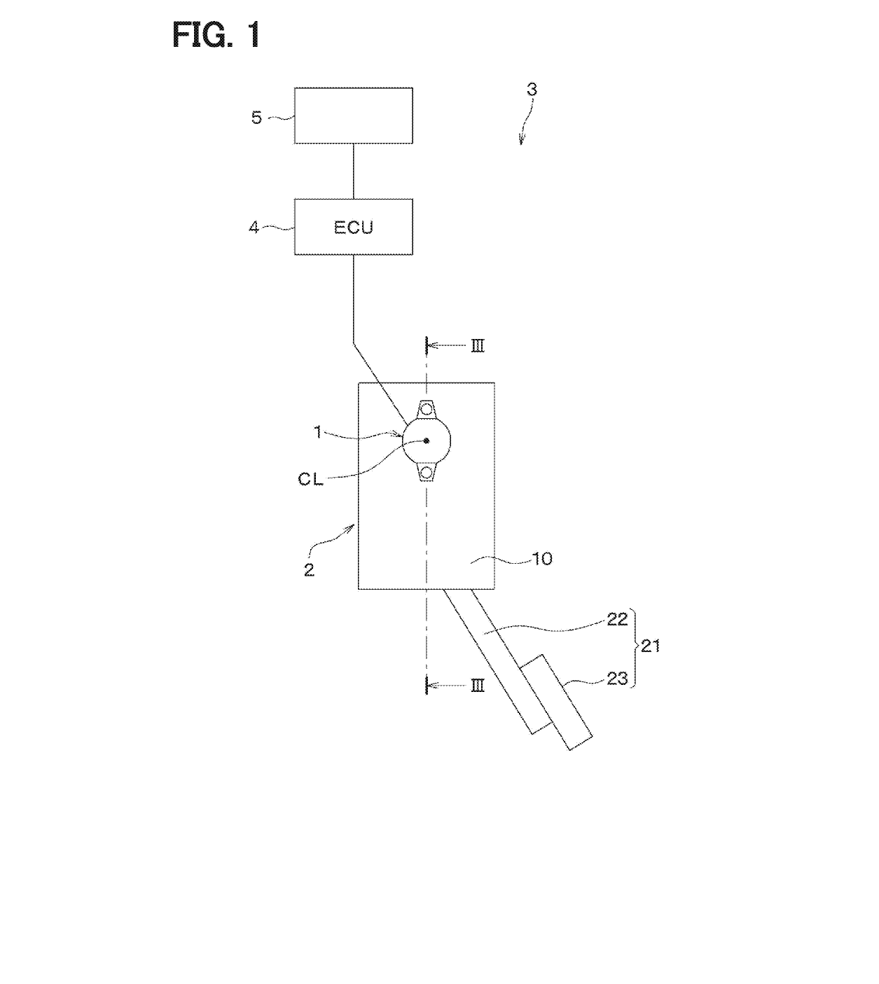

A first embodiment will be described. As shown in FIG. 1, a rotation angle detection device 1 of the first embodiment is used in a brake pedal device 2 mounted on a vehicle. The brake pedal device 2 constitutes a part of a brake-by-wire system 3 that controls the braking of the vehicle. The brake-by-wire system 3 is a system in which a brake mechanism 5 applies brakes to the vehicle under a drive control of an electronic control unit (hereinafter, referred to as "ECU 4") mounted on the vehicle. The ECU 3 is an abbreviation for Electronic Control Unit.

Configuration of brake pedal device and brake-by-wire system:

First, the general configuration of the brake pedal device 2 and the brake-by-wire system 3 will be described.

As shown in FIGS. 1 to 3, the brake pedal device 2 includes a housing 10 as a support body, and a shaft member 20, a brake pedal 21, and a rotation angle detection device 1 as a rotating body.

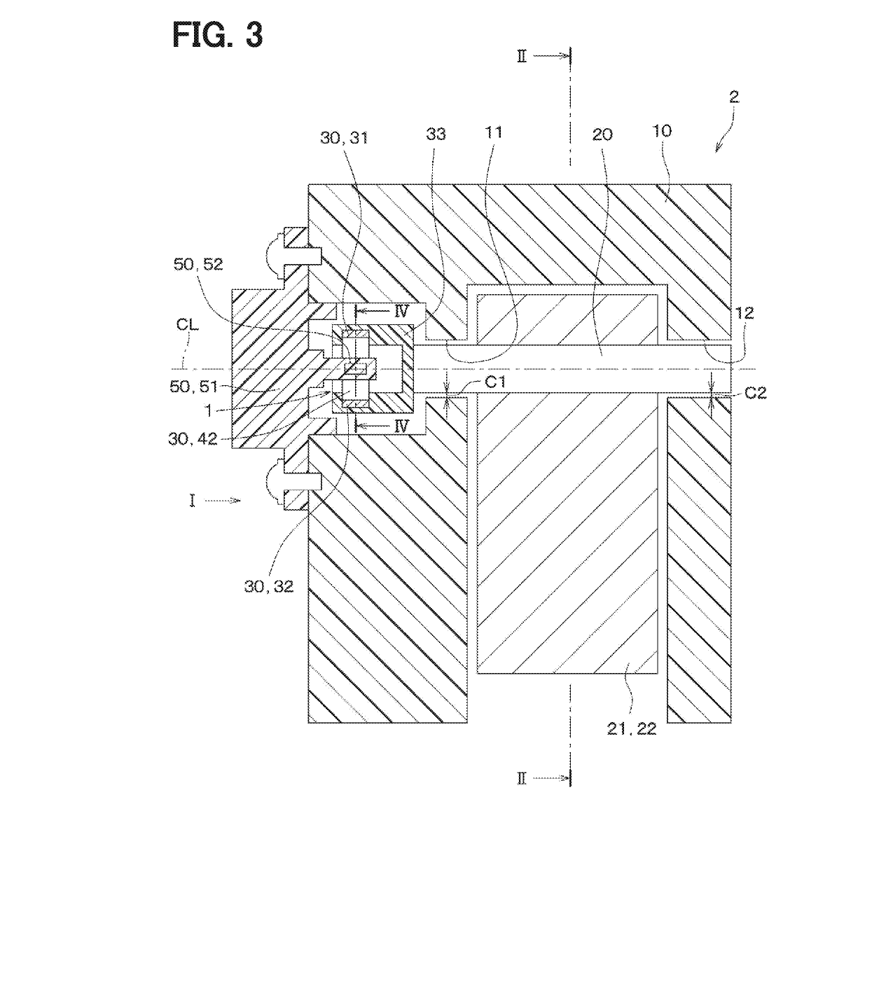

The housing 10 is directly fixed to a vehicle body by bolts or the like (not shown), or is indirectly fixed to the vehicle body via a base member or the like (not shown). Specifically, the housing 10 is fixed to a dash panel or a floor inside the vehicle compartment. As shown in FIG. 3, bearings 11 and 12 for rotatably supporting the shaft member 20 are provided inside the housing 10. The bearings 11 and 12 may be, for example, rolling bearings or plain bearings.

The shaft member 20 is formed in a rod shape and is supported by bearings 11 and 12 provided in the housing 10. The shaft member 20 is provided to the housing 10 so as to be rotatable within a predetermined angular range around its own axis CL as a center of rotation. Slight clearances C1 and C2 are provided between the shaft member 20 and the bearings 11 and 12 to allow the shaft member 20 to rotate.

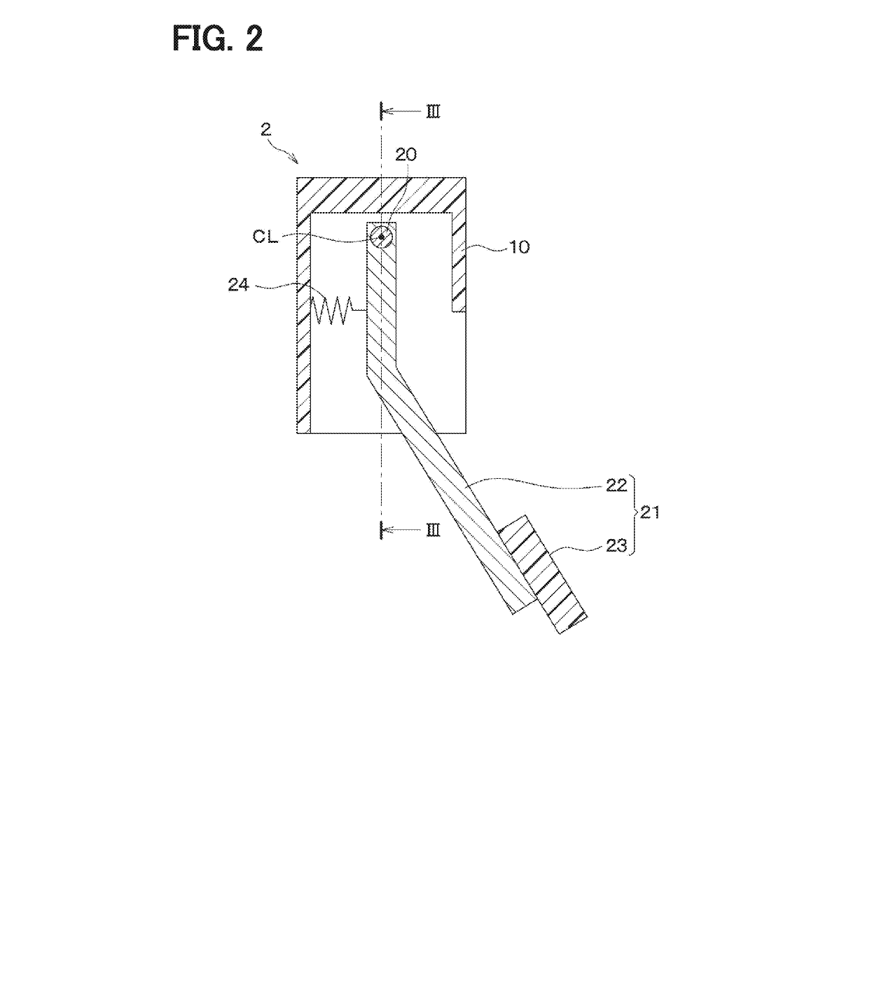

As shown in FIG. 2, the brake pedal 21 includes a pedal arm 22 and a pedal pad 23. The pedal arm 22 has one end fixed to the shaft member 20 and the other end provided with a pedal pad 23. The pedal pad 23 is a portion that is stepped on by the driver's foot. When the driver depresses the brake pedal 21, the brake pedal 21 rotates in the forward and reverse directions within a predetermined angular range around the axis CL of the shaft member 20. In the present disclosure, "rotation" also includes "swinging."

A reaction force generating mechanism 24 is composed of, for example, a spring, an actuator, and the like. The reaction force generating mechanism 24 is a mechanism that generates a reaction force against the driver's depressing force applied to the brake pedal 21. By providing the reaction force generating mechanism 24, the brake pedal device 2 is able to obtain a reaction force similar to that obtained when the brake pedal 21 is connected to a master cylinder (i.e., when a reaction force is obtained by hydraulic pressure) even if the mechanical connection between the brake pedal 8 and a conventional master cylinder is eliminated.

As shown in FIG. 1, the rotation angle detection device 1 detects the rotation angle of the shaft member 20 and the brake pedal 21, which are rotating bodies, relative to the housing 10, which is a support body. The electrical signal output from the rotation angle detection device 1 is transmitted to the ECU 4.

The ECU 4 includes a microcontroller having a processor for performing control processing and arithmetic processing, and a storage unit, such as a ROM and a RAM, for storing programs and data. The controller also includes peripheral circuits for these components. The storage unit includes non-transitory tangible storage media. Based on programs stored in the storage unit, the ECU 4 performs various types of control processing and arithmetic processing to control the operation of devices connected to output ports of the ECU 3. Specifically, the ECU 4 detects the rotation angle of the shaft member 20 and the brake pedal 21, i.e., the amount of operation of the brake pedal 21, based on the electrical signal transmitted from the rotation angle detection device 1, and controls the operation of the brake mechanism 5.

As the brake mechanism 5, various mechanisms can be adopted. For example, the brake mechanism 5 may be an electric brake that applies brakes to each wheel by driving an electric motor in response to a command from the ECU 4 to press brake pads against a disc brake rotor. Alternatively, for example, the brake mechanism 5 may be configured to increase the hydraulic pressure of the brake fluid by operating a master cylinder or a hydraulic pump, thereby driving wheel cylinders arranged on each wheel and operating the brake pads.

Configuration of rotation angle detection device:

Next, the rotation angle detection device 1 will be described.

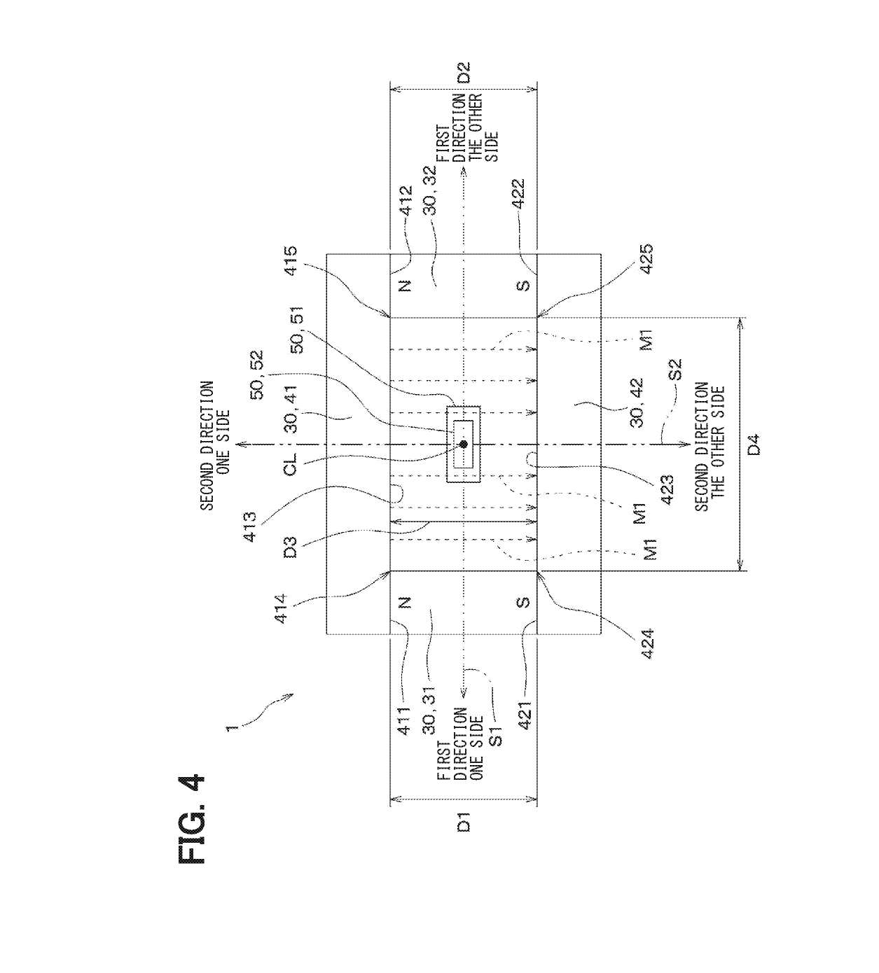

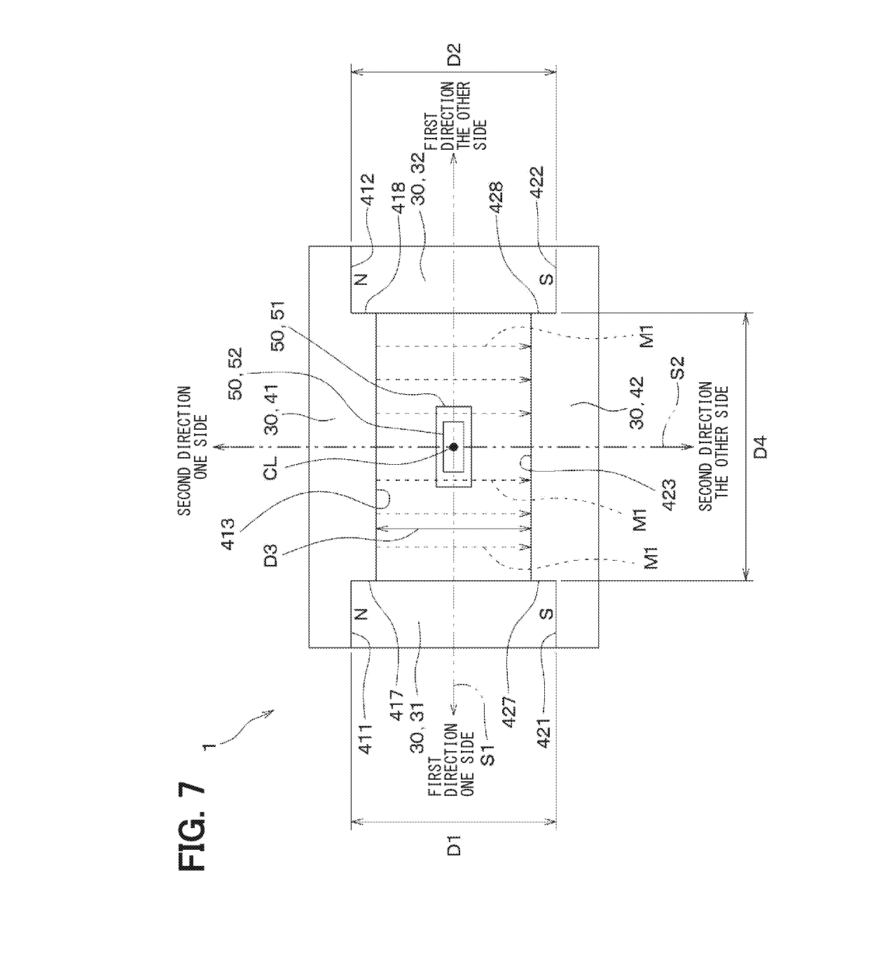

As shown in FIGS. 3 and 4, the rotation angle detection device 1 includes a magnetic circuit 30, a magnetic detection unit 50, and the like. The magnetic circuit 30 has a first magnet 31, a second magnet 32, a first yoke 41, and a second yoke 42, and is formed in a rectangular cylindrical shape. Therefore, when viewed in the direction in which the axis CL extends, the inner wall surface of the magnetic circuit 30 is formed in a rectangular shape. As shown in FIG. 3, the first magnet 31, the second magnet 32, the first yoke 41 and the second yoke 42 are molded in a resin body 33 and fixed to the end of the shaft member 20 using bolts or the like (not shown). Therefore, the positional relationship between the magnetic circuit 30 and the axis CL of the shaft member 20 is fixed. In FIGS. 4 to 6, as well as FIGS. 7 to 10 referenced in each embodiment and comparative example below, the illustration of the resin body 33 that molds the magnetic circuit 30 and the hatching indicating the cross-sections of each component are omitted.

On the other hand, as shown in FIG. 3, the magnetic detection unit 50 includes a resin part 51 and a magnetic detection element 52. The magnetic detection element 52 is resin-molded by the resin part 51. The magnetic detection element 52 outputs an electric signal corresponding to the magnetic field in the inner region of the magnetic circuit 30. More specifically, the magnetic detection element 52 outputs an electric signal according to the magnitude of the magnetic flux density passing through its own magnetic sensing surface in the magnetic field in the inner region of the magnetic circuit 30. The magnetic detection element 52 may be, for example, a Hall element or a magnetoresistive element. The Hall element or the magnetoresistive element is incorporated into an integrated circuit (hereinafter referred to as "IC") for use. IC stands for an integrated circuit.

The resin part 51 of the magnetic detection unit 50 is fixed to the housing 10 so that the magnetic detection element 52 is positioned on the axis CL. The resin part 51 of the magnetic detection unit 50 can be fixed to the housing 10 by various methods such as bolting, press-fitting, fitting, snap-fitting, and the like. A phrase "the magnetic detection element 52 is positioned on the axis CL" means, from a design perspective (i.e., on paper), that the magnetic detection element 52 is arranged on the axis CL of the shaft member 20. In reality, the magnetic detection element 52 may be displaced from its position on the axis CL of the shaft member 20 due to clearances C1 and C2 between the shaft member 20 and the bearings 11 and 12, manufacturing tolerances, and the like.

FIG. 4 shows a state in which the magnetic detection element 52 of the magnetic detection unit 50 is positioned on the axis CL. However, as described above, in reality, slight clearances C1 and C2 are provided between the shaft member 20 and the bearings 11 and 12 to allow the shaft member 20 to rotate. Therefore, during use of the brake pedal device 2, the magnetic detection unit 50 fixed to the housing 10 and the magnetic circuit 30 fixed to the shaft member 20 may become misaligned. Therefore, the magnetic detection element 52 of the magnetic detection unit 50 may move from the axis CL within the range of the inner region of the magnetic circuit 30.

In the following description, a direction in which an imaginary line connecting the center of the first magnet 31 and the center of the second magnet 32 extends, as shown in FIG. 4, will be referred to as a "first direction." A direction in which the axis CL extends and the direction perpendicular to the first direction are referred to as a "second direction." In addition, the first magnet 31 side relative to the axis CL will be described as "one side in the first direction," the second magnet 32 side relative to the axis CL as "the other side in the first direction," the first yoke 41 side relative to the axis CL as "one side in the second direction," and the second yoke 42 side relative to the axis CL as "the other side in the second direction."

Furthermore, in the following description, a predetermined imaginary plane that includes the axis CL and is parallel to the second direction will be referred to as a "second imaginary plane S2." Furthermore, another imaginary plane that includes the axis CL and is parallel to the first direction is referred to as a "first imaginary plane S1."

The first magnet 31 and the second magnet 32 are arranged facing each other in the first direction with the axis CL of the shaft member 20 positioned between them. The term "facing arrangement" refers to arrangement in which the components face each other. The first magnet 31 and the second magnet 32 are both permanent magnets, and are formed in a rectangular parallelepiped or cylindrical shape. The first magnet 31 and the second magnet 32 are both arranged so that their magnetization directions are parallel to the second direction and are in the same direction. Specifically, the first magnet 31 and the second magnet 32 are arranged so that a north pole faces one side of the second direction and a south pole faces the other side of the second direction.

The first yoke 41 and the second yoke 42 are disposed opposite each other in the second direction with the axis CL of the shaft member 20 interposed therebetween. Both the first yoke 41 and the second yoke 42 are made of a magnetic material and are formed in the shape of a flat plate or a rectangular parallelepiped. The first yoke 41 and the second yoke 42 both connect the same poles of the first magnet 31 and the second magnet 32. Specifically, the first yoke 41 connects the north pole of the first magnet 31 and the north pole of the second magnet 32. The second yoke 42 connects the south pole of the first magnet 31 and the south pole of the second magnet 32.

The first yoke 41 and the second yoke 42 are arranged parallel to the first direction. In detail, the surface of the first yoke 41 facing the second yoke 42 between the first magnet 31 and the second magnet 32 (hereinafter referred to as a "first yoke inner wall surface 413") is planar and parallel to the first direction, extending from the first magnet 31 to the second magnet 32. In addition, the surface of the second yoke 42 facing the first yoke 41 between the first magnet 31 and the second magnet 32 (hereinafter referred to as the "second yoke inner wall surface 423") is also planar and parallel to the first direction, extending from the first magnet 31 to the second magnet 32.

In the present disclosure, "parallel" means substantially parallel in light of the intent of the present disclosure, and includes not only perfect parallelism but also slight non-parallelism due to, for example, manufacturing tolerances. In the present disclosure, the term "planar" refers to a substantially flat surface within the meaning of the present disclosure, and includes a completely flat surface as well as a slightly non-flat surface due to, for example, manufacturing tolerances.

Here, the distance between the portion 411 of the first yoke 41 facing the north pole of the first magnet 31 and the portion 421 of the second yoke 42 facing the south pole of the first magnet 31 is referred to as the first magnet distance D1. The distance between a portion 412 of the first yoke 41 facing the north pole of the second magnet 32 and a portion 422 of the second yoke 42 facing the south pole of the second magnet 32 is referred to as the second magnet distance D2. The distance between the first yoke inner wall surface 413 and the second yoke inner wall surface 423 is referred to as a yoke inner wall distance D3.

In the first embodiment, the first magnet distance D1, the second magnet distance D2, and the yoke inner wall distance D3 are the same. In the present disclosure, "same" means substantially the same in light of the intent of this disclosure, and includes not only complete sameness but also slight non-identity due to, for example, manufacturing tolerances.

Furthermore, the distance D4 between the first magnet 31 and the second magnet 32 is greater than the yoke inner wall distance D3.

In FIG. 4, for ease of explanation, the boundary between the portion 411 of the first yoke 41 facing the N pole of the first magnet 31 and the first yoke inner wall surface 413 is indicated by an arrow 414. The boundary between the portion 412 of the first yoke 41 facing the N pole of the second magnet 32 and the first yoke inner wall surface 413 is indicated by an arrow 415. However, the portion 411 of the first yoke 41 facing the N pole of the first magnet 31, the first yoke inner wall surface 413, and the portion 412 of the first yoke 41 facing the N pole of the second magnet 32 are formed as a continuous plane.

In addition, in FIG. 4, for ease of explanation, the boundary between a portion 421 of the second yoke 42 facing the south pole of the first magnet 31 and an second yoke inner wall surface 423 is indicated by an arrow 424. The boundary between a portion 422 of the second yoke 42 facing the south pole of the second magnet 32 and an second yoke inner wall surface 423 is indicated by an arrow 425. However, the portion 421 of the second yoke 42 facing the south pole of the first magnet 31, the second yoke inner wall surface 423, and the portion 422 of the second yoke 42 facing the south pole of the second magnet 32 are formed as a continuous plane.

The magnetic circuit 30 is symmetrical with respect to the second imaginary plane S2. The magnetic circuit 30 is also symmetrical with respect to the first imaginary plane S1. In the present disclosure, "symmetric" means substantially symmetric in light of the gist of the present disclosure, and includes not only perfect symmetry but also slight asymmetry due to, for example, manufacturing tolerances.

Specifically, the magnetic circuit 30 is symmetrical with respect to the second imaginary plane S2 when the first magnet 31 and the second magnet 32 have the same shape, size, material properties, etc., and the distance between the first magnet 31 and the second imaginary plane S2 is the same as the distance between the second magnet 32 and the second imaginary plane S2. Furthermore, the first yoke 41 has the same shape, size, material properties, etc. between the portions on one side and the other side across the second imaginary plane S2. Similarly, the second yoke 42 has the same shape, size, material properties, etc. on one side and the other side of the second imaginary plane S2.

The magnetic circuit 30 is symmetrical with respect to the first imaginary plane S1 when the first yoke 41 and the second yoke 42 have the same shape, size, material properties, etc., and the distance between the first yoke 41 and the first imaginary plane S1 is the same as the distance between the second yoke 42 and the first imaginary plane S1. Furthermore, the first magnet 31 has the same shape, size, material properties, etc. on one side and the other side of the first imaginary plane S1. Similarly, the second magnet 32 has the same shape, size, material properties, etc. on one side and the other side of the first imaginary plane S1.

Generally, the magnetic field emitted from the inner wall surface of the yoke into space is emitted perpendicular to the inner wall surface of the yoke. In FIG. 4, the magnetic field emitted from the first yoke inner wall surface 413, passing through the inner region of the magnetic circuit 30, and heading toward the second yoke inner wall surface 423 (i.e., the magnetic field in the inner region of the magnetic circuit 30) is indicated by multiple dashed arrows M1. Due to the above-described configuration of the magnetic circuit 30, the inner region of the magnetic circuit 30 becomes a substantially parallel magnetic field. Therefore, even if the magnetic detection unit 50 moves from the axis CL while the brake pedal device 2 is in use, as a result of the movement, variation in the direction of the magnetic field passing through the magnetic detection unit 50 is suppressed. Therefore, the rotation angle detection device 1 can improve the detection accuracy of the rotation angles of the shaft member 20 and the brake pedal 21 relative to the housing 10.

Method for detecting rotation angle using rotation angle detection device:

Next, single-axis detection and two-axis detection will be described as examples of the method for detecting the rotation angle by the rotation angle detection device 1. Single-axis detection is also called scalar detection. Two-axis detection is also called vector detection.

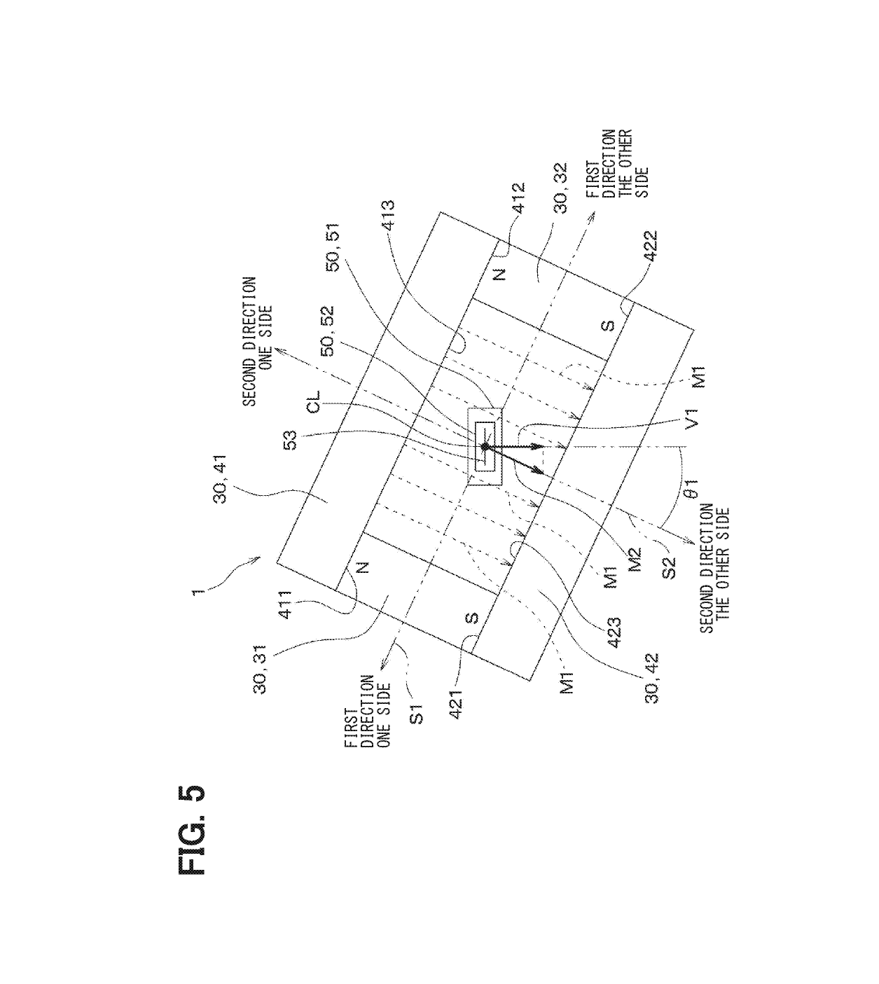

First, the single-axis detection will be described with reference to FIG. 5. FIG. 5 shows a state in which the magnetic circuit 30 has been rotated by a predetermined angle clockwise relative to the magnetic detection unit 50 from the state shown in FIG. 4. In FIG. 5, the angle by which the magnetic circuit 30 has rotated from the state shown in FIG. 4 is indicated by θ1. When the rotation angle detection device 1 performs single-axis detection, the magnetic detection element 52 of the magnetic detection unit 50 has at least one magnetic sensing surface 53, as shown in FIG. 5. The magnetic detection unit 50 outputs a signal according to the density of magnetic flux passing through a magnetic sensing surface 53 arranged in a predetermined direction. When the direction of the magnetic field passing through the magnetic sensing surface 53 of the magnetic detection element 52 changes with the rotation of the magnetic circuit 30, the density of the magnetic flux passing through the magnetic sensing surface 53 changes accordingly. In FIG. 5, for ease of explanation, the direction and magnitude of the magnetic field passing through the magnetic detection element 52 is indicated by an arrow M2, and the magnitude of the signal output by the magnetic detection element 52 in accordance with the magnetic flux density passing through the magnetic sensing surface 53 is indicated by an arrow V1. The IC or ECU 4 of the magnetic detection unit 50 stores the relationship between the magnitude of the signal output by the magnetic detection element 52 and the direction of the magnetic field passing through the magnetic detection element 52, i.e., the rotation angle θ1 of the magnetic circuit 30 in advance. Therefore, the IC or ECU 4 of the magnetic detection unit 50 can calculate the direction of the magnetic field passing through the magnetic detection element 52, i.e., the rotation angle θ1 of the magnetic circuit 30, based on the magnitude of the signal output according to the magnetic flux density passing through the magnetic sensing surface 53. With this configuration, the IC or ECU 4 of the magnetic detection unit 50 is capable of detecting the rotational angle of the shaft member 20 and the brake pedal 21 relative to the housing 10.

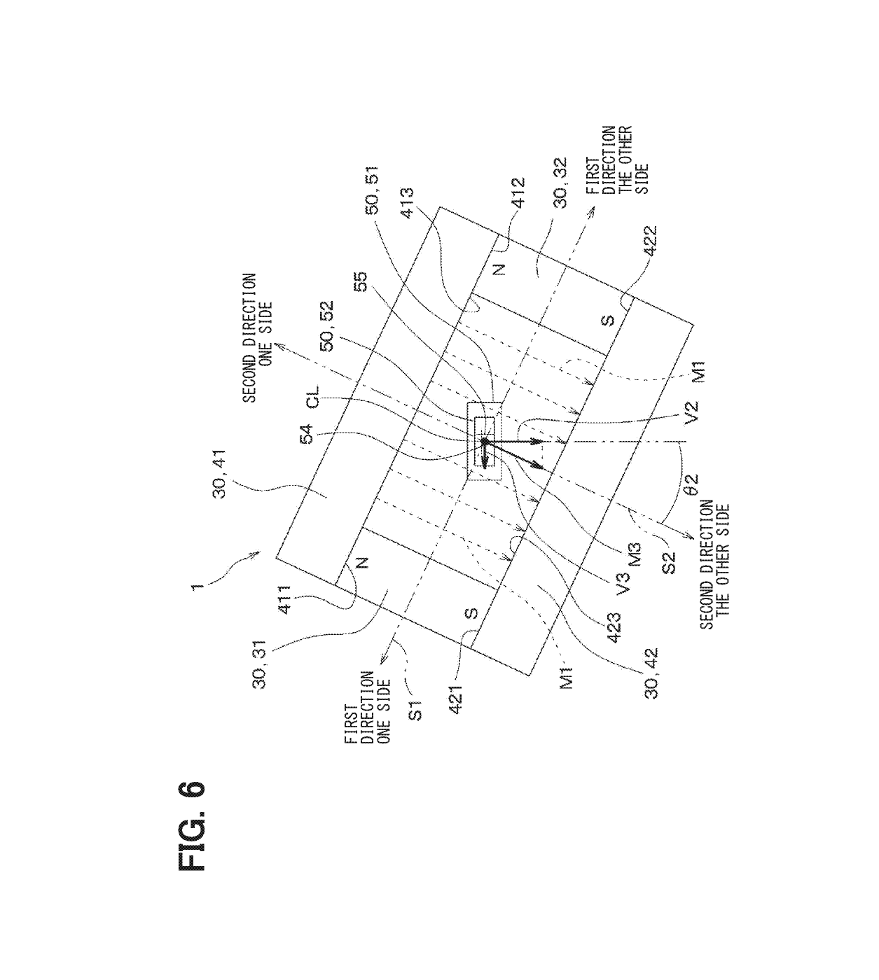

Next, two-axis detection will be described. FIG. 6 also shows a state in which the magnetic circuit 30 has been rotated by a predetermined angle clockwise relative to the magnetic detection unit 50 from the state shown in FIG. 4. In FIG. 6, the angle by which the magnetic circuit 30 has rotated from the state shown in FIG. 4 is indicated by θ2. As shown in FIG. 6, when the rotation angle detection device 1 performs two-axis detection, the magnetic detection element 52 has a plurality of magnetic sensing surfaces 54 and 55. Of the multiple magnetic sensing surfaces 54, 55, the first magnetic sensing surface 54 and the second magnetic sensing surface 55 are arranged in different directions (specifically, orthogonal directions). Therefore, with respect to the direction of the magnetic field passing through the magnetic detection element 52 as the magnetic circuit 30 rotates, the magnetic flux density passing through the first magnetic sensing surface 54 is different from the magnetic flux density passing through the second magnetic sensing surface 55. Therefore, the magnetic detection element 52 outputs a signal of different magnitude based on the magnetic flux density passing through the first magnetic sensing surface 54 and a signal of different magnitude based on the magnetic flux density passing through the second magnetic sensing surface 55.

For ease of explanation, in FIG. 6, the direction and magnitude of the magnetic field passing through the magnetic detection element 52 are indicated by an arrow M3. In addition, the magnitude of the signal output based on the magnetic flux density passing through the first magnetic sensing surface 54 is indicated by an arrow V2, and the magnitude of the signal output based on the magnetic flux density passing through the second magnetic sensing surface 55 is indicated by an arrow V3. The IC of the magnetic detection unit 50 or the ECU 4 can calculate the direction of the magnetic field passing through the magnetic detection unit 50 using the arc tangent from the magnitude of the signal output based on the magnetic flux density passing through the first magnetic sensing surface 54 and the magnitude of the signal output based on the magnetic flux density passing through the second magnetic sensing surface 55. That is, the IC of the magnetic detection unit 50 or the ECU 4 can calculate the rotation angle θ2 of the magnetic circuit 30. Therefore, the IC of the magnetic detection unit 50 or the ECU 4 can detect the rotation angles of the shaft member 20 and the brake pedal 21 relative to the housing 10.

In the inner region of the magnetic circuit 30, the strength of the magnetic field increases toward the first yoke 41 and the second yoke 42 relative to the intermediate position between the first yoke 41 and the second yoke 42 (i.e., near the axis CL). Therefore, in the above-described single-axis detection, when the magnetic detection unit 50 moves from the axis CL in the second direction, the detection accuracy of the rotation angle may be reduced. In contrast, two-axis detection can accurately detect the rotation angle even if the magnetic detection unit 50 moves from the axis CL to one side or the other side in the second direction due to clearances C1, C2 between the shaft member 20 and the bearings 11, 12, etc.

Rotation angle detection device of comparative example:

Here, a rotation angle detection device 100 of a comparative example will be described for comparison with the rotation angle detection device 1 of the first embodiment described above.

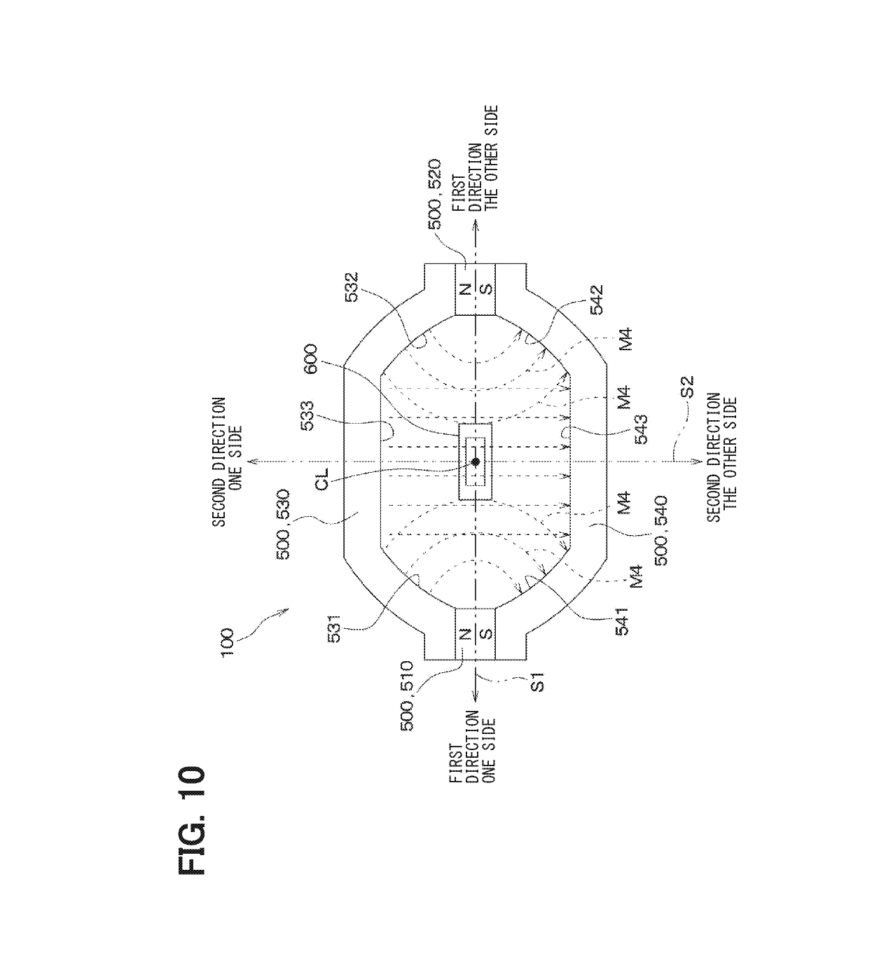

As shown in FIG. 10, the rotation angle detection device 100 of the comparative example also includes a magnetic circuit 500 and a magnetic detection unit 600. The magnetic circuit 500 includes a first magnet 510, a second magnet 520, a first yoke 530, and a second yoke 540. The first yoke 530 has a first concave curved surface 531 that extends from the first magnet 510 side toward the center portion and away from the first imaginary plane S1, and a second concave curved surface 532 that extends from the second magnet 520 side toward the center portion and away from the first imaginary plane S1. The first yoke 530 has a first yoke-side parallel portion 533 formed in the center portion between the first concave curved surface 531 and the second concave curved surface 532 and parallel to the first imaginary plane S1.

The second yoke 540 also has a third concave curved surface 541 extending from the first magnet 510 side toward the center and away from the first imaginary plane S1, and a fourth concave curved surface 542 extending from the second magnet 520 side toward the center and away from the first imaginary plane S1. The second yoke 540 also has a second yoke-side parallel portion 543 formed in the center between the third concave curved surface 541 and the fourth concave curved surface 542, which is parallel to the first imaginary plane S1.

In FIG. 10, the magnetic field emitted from the inner wall surface of the first yoke 530, passing through the inner region of the magnetic circuit 500, and heading toward the inner wall surface of the second yoke 540 is indicated by a plurality of dashed arrows M4. As indicated by the dashed arrows M4, part of the magnetic field emitted from the first to fourth concave curved surfaces 531, 532, 541, 542 of the yoke passes near the axis CL in the inner region of the magnetic circuit 500. Therefore, in the inner region of the magnetic circuit 500 including the axis CL and the vicinity of the axis CL, the parallel magnetic field range in which only parallel components of the magnetic field exist is small and is not affected by the magnetic fields emitted from the first to fourth concave curved surfaces 531, 532, 541, 542. Therefore, in the configuration of the comparative example, when the magnetic detection unit 600 moves from a position on the axis CL to outside the parallel magnetic field range during use of the brake pedal device 2, the direction of the magnetic field passing through the magnetic detection unit 600 may change even though the magnetic circuit 500 is not rotating. Therefore, in the rotation angle detection device 100 of the comparative example, when the magnetic detection unit 600 outputs a signal corresponding to the direction of the magnetic field that has changed due to its own movement, there is a risk that the detection accuracy of the rotation angle of the shaft member 20 and the brake pedal 21 relative to the housing 10 will decrease.

### Operation and Effect of First Embodiment:

Compared with the rotation angle detection device 100 of the comparative example, the rotation angle detection device 1 of the first embodiment has the following advantages.

(1) In the first embodiment, the first yoke 41 and the second yoke 42 are arranged facing each other in the second direction across the axis CL, and the first magnet distance D1, the second magnet distance D2, and the yoke inner wall distance D3 are the same.

This results in a configuration in which the magnetic field emitted from the portions of the yokes 41 and 42 near the magnets 31 and 32 and passing through the inner region of the magnetic circuit 30 does not affect the magnetic field emitted from the portions of the yokes 41 and 42 other than the central portion and passing through the inner region of the magnetic circuit 30. The central portions of the yokes 41 and 42 are the portions of the yokes 41 and 42 excluding the portions near the magnets 31 and 32. This allows the range of the parallel magnetic field to be increased in the inner region of the magnetic circuit 30 including the axis CL and the vicinity of the axis CL. Therefore, even if the magnetic detection unit 50 moves from the axis CL due to a misalignment between the housing 10 and the shaft member 20, the direction of the magnetic field passing through the magnetic detection unit 50 is prevented from changing due to that movement. Therefore, the rotation angle detection device 1 can improve the detection accuracy of the rotation angles of the shaft member 20 and the brake pedal 21 relative to the housing 10.

(2) In the first embodiment, the first yoke inner wall surface 413 and the second yoke inner wall surface 423 are both flat surfaces parallel to the first direction.

This allows the magnetic field emitted from the first yoke inner wall surface 413, passing through the inner region of the magnetic circuit 30 and heading toward the second yoke inner wall surface 423 to be a parallel magnetic field. Therefore, the range of the parallel magnetic field can be increased in the inner region of the magnetic circuit 30 including the axis CL and the vicinity of the axis CL.

(3) In the first embodiment, both the first yoke inner wall surface 413 and the second yoke inner wall surface 423 are flat surfaces that extend between the first magnet 31 and the second magnet 32 and are parallel to the first direction.

This allows the magnetic field in the inner region of the magnetic circuit 30 to be a parallel magnetic field extending between the first magnet 31 and the second magnet 32. Therefore, the range of the parallel magnetic field can be increased in the inner region of the magnetic circuit 30.

(4) In the first embodiment, both the first yoke 41 and the second yoke 42 may be formed in a flat plate shape or a rectangular parallelepiped shape. This simplifies the configuration of the yokes 41 and 42, thereby reducing the number of manufacturing steps.

In the present disclosure, "flat shape" refers to a substantially flat plate in light of the intent of the present disclosure, and includes not only a completely flat plate but also slight deformations due to manufacturing tolerances, rounded corners, etc. Furthermore, in the present disclosure, "rectangular parallelepiped shape" refers to a substantially rectangular prism in light of the intent of the present disclosure, and includes not only a perfect rectangular prism, but also slight deformations due to manufacturing tolerances, etc., and rounded corners.

(5) In the first embodiment, the magnetic circuit 30 is symmetrical with respect to the second imaginary plane S2.

According to this configuration, the direction and strength of the magnetic field in the inner region of the magnetic circuit 30 are symmetrical with respect to the second imaginary plane S2. Therefore, even if the magnetic detection unit 50 moves from the axis CL to one side or the other in the first direction due to a misalignment between the housing 10 and the shaft member 20, the direction and strength of the magnetic field passing through the magnetic detection unit 50 are prevented from changing due to that movement. Therefore, the rotation angle detection device 1 can improve the detection accuracy of the rotation angles of the shaft member 20 and the brake pedal 21 despite the misalignment between the housing 10 and the shaft member 20 in the first direction.

(6) In the first embodiment, the magnetic circuit 30 is symmetrical with respect to the second imaginary plane S2 and is symmetrical with respect to the first imaginary plane S1.

As a result, the direction and strength of the magnetic field in the inner region of the magnetic circuit 30 are symmetrical with respect to the second imaginary plane S2 and also with respect to the first imaginary plane S1. Therefore, even if the magnetic detection unit 50 shifts in position from the axis CL in the first and second directions due to a misalignment between the housing 10 and the shaft member 20, the direction and strength of the magnetic field passing through the magnetic detection unit 50 are prevented from changing due to these movements. Therefore, the rotation angle detection device 1 can improve the detection accuracy of the rotation angle of the shaft member 20 and the brake pedal 21 despite the misalignment between the housing 10 and the shaft member 20 in the first direction and the second direction.

(7) In the first embodiment, the distance D4 between the first magnet 31 and the second magnet 32 is greater than the yoke inner wall distance D3.

By increasing the distance between the magnets 31 and 32 and the magnetic detection unit 50, the magnetic field leaking from the magnets 31 and 32 can be prevented from affecting the magnetic field near the axis CL in the inner region of the magnetic circuit 30.

(8) In the first embodiment, both the first magnet 31 and the second magnet 32 may be rectangular parallelepiped. This simplifies the configuration of the magnets 31 and 32, thereby reducing the number of manufacturing steps.

(9) In the first embodiment, both the first magnet 31 and the second magnet 32 may be cylindrical. This simplifies the configuration of the magnets 31 and 32, thereby reducing the number of manufacturing steps.

In the present disclosure, "cylindrical" refers to a substantially cylindrical shape in light of the intent of the present disclosure, and includes not only a perfect cylinder but also slight deformations due to manufacturing tolerances, rounded edges, etc.

(10) In the first embodiment, the magnetic detection unit 50 can be configured to perform single-axis detection. In this case, the IC or ECU 4 of the magnetic detection unit 50 calculates the direction of the magnetic field passing through the magnetic detection element 52 based on the magnitude of the signal output according to the magnetic flux density passing through at least one magnetic sensing surface 53 of the magnetic detection element 52.

This allows the rotation angle detection device 1 to simplify the configuration of the magnetic detection element 52 and the angle detection logic, thereby reducing manufacturing costs.

(11) In the first embodiment, the magnetic detection unit 50 can be configured to perform two-axis detection. In this case, the magnetic detection element 52 has a first magnetic sensing surface 54 arranged in a predetermined direction and a second magnetic sensing surface 55 arranged in a direction different from that of the first magnetic sensing surface 54. The IC or ECU 4 of the magnetic detection unit 50 then calculates the direction of the magnetic field passing through the magnetic detection element 52 based on the magnitude of the signal output in accordance with the magnetic flux density passing through the first magnetic sensing surface 54 and the magnitude of the signal output in accordance with the magnetic flux density passing through the second magnetic sensing surface 55.

According to this configuration, the strength of the magnetic field in the inner region of the magnetic circuit 30 becomes stronger as it approaches the first yoke 41 and the second yoke 42 relative to the intermediate position between the first yoke 41 and the second yoke 42 (i.e., near the axis CL). In contrast, with two-axis detection, the rotation angle can be detected with high accuracy even when the magnetic detection unit 50 moves from the axis CL to one side or the other side in the second direction.

(12) In the first embodiment, a Hall element may be used as the magnetic detection element 52. According to this configuration, by using a general-purpose magnetic detection element 52, the manufacturing cost can be reduced.

(13) In the first embodiment, the magnetic detection element 52 may be a magnetoresistive element. According to this configuration, by using a general-purpose magnetic detection element 52, the manufacturing cost can be reduced.

(14) The rotation angle detection device 1 of the first embodiment is used in the brake pedal device 2 and detects the rotation angle of the shaft member 20 and the brake pedal 21 relative to the housing 10.

According to this configuration, the rotation angle detection device 1 used in the brake pedal device 2 is required to detect the angle with high accuracy even when the housing 10 and the shaft member 20 are misaligned. In response to the requirements specific to the brake pedal device 2, the rotation angle detection device 1 can detect with high accuracy the rotation angle of the shaft member 20 and the brake pedal 21 relative to the housing 10, even if the magnetic detection unit 50 moves from the axis CL due to a positional misalignment between the housing 10 and the shaft member 20.

Therefore, the brake pedal device 2 can prevent the driver from suddenly decelerating unintentionally when the driver applies a small amount of pressure to the brake pedal 21, for example. Furthermore, the brake pedal device 2 can prevent the brakes from being applied unintentionally by the driver when, for example, the driver is not applying a pedal force to the brake pedal 21 while the vehicle is running.

### Second Embodiment:

A second embodiment will be described. The second embodiment is similar to the first embodiment except for a part of the configuration of the magnetic circuit 30 modified from the corresponding configuration of the first embodiment. Accordingly, only parts different from the corresponding parts of the first embodiment are herein described.

As shown in FIG. 7, in the magnetic circuit 30 provided in the rotation angle detection device 1 of the second embodiment, the first magnet distance D1 and the second magnet distance D2 are both greater than the yoke inner wall distance D3. The first magnet distance D1 and the second magnet distance D2 are the same.

Specifically, the portion 411 of the first yoke 41 facing the N pole of the first magnet 31 and the portion 412 of the first yoke 41 facing the N pole of the second magnet 32 are both located on one side in the second direction relative to the first yoke inner wall surface 413. Therefore, a step 417 is provided between the portion 411 of the first yoke 41 that faces the N pole of the first magnet 31 and the first yoke inner wall surface 413. A step 418 is also provided between the portion 412 of the first yoke 41 that faces the N pole of the second magnet 32 and the first yoke inner wall surface 413.

Similarly, the portion 421 of the second yoke 42 facing the south pole of the first magnet 31 and the portion 422 of the second yoke 42 facing the south pole of the second magnet 32 are both located on the other side in the second direction relative to the second yoke inner wall surface 423. Therefore, a step 427 is provided between the portion 421 of the second yoke 42 that faces the south pole of the first magnet 31 and the inner wall surface 423 of the second yoke. A step 428 is also provided between the portion 422 of the second yoke 42 that faces the south pole of the second magnet 32 and the second yoke inner wall surface 423.

In the second embodiment, the first yoke inner wall surface 413 and the second yoke inner wall surface 423 are both flat surfaces that extend from the first magnet 31 to the second magnet 32 and are parallel to the first direction. Furthermore, the magnetic circuit 30 is symmetrical with respect to the second imaginary plane S2 and also symmetrical with respect to the first imaginary plane S1.

The second embodiment described above can also achieve the same effects as the first embodiment.

### Third Embodiment:

A third embodiment will be described. The third embodiment is similar to the first embodiment except for a part of the configuration of the magnetic circuit 30 modified from the corresponding configuration of the first embodiment. Accordingly, only parts different from the corresponding parts of the first and second embodiments are herein described.

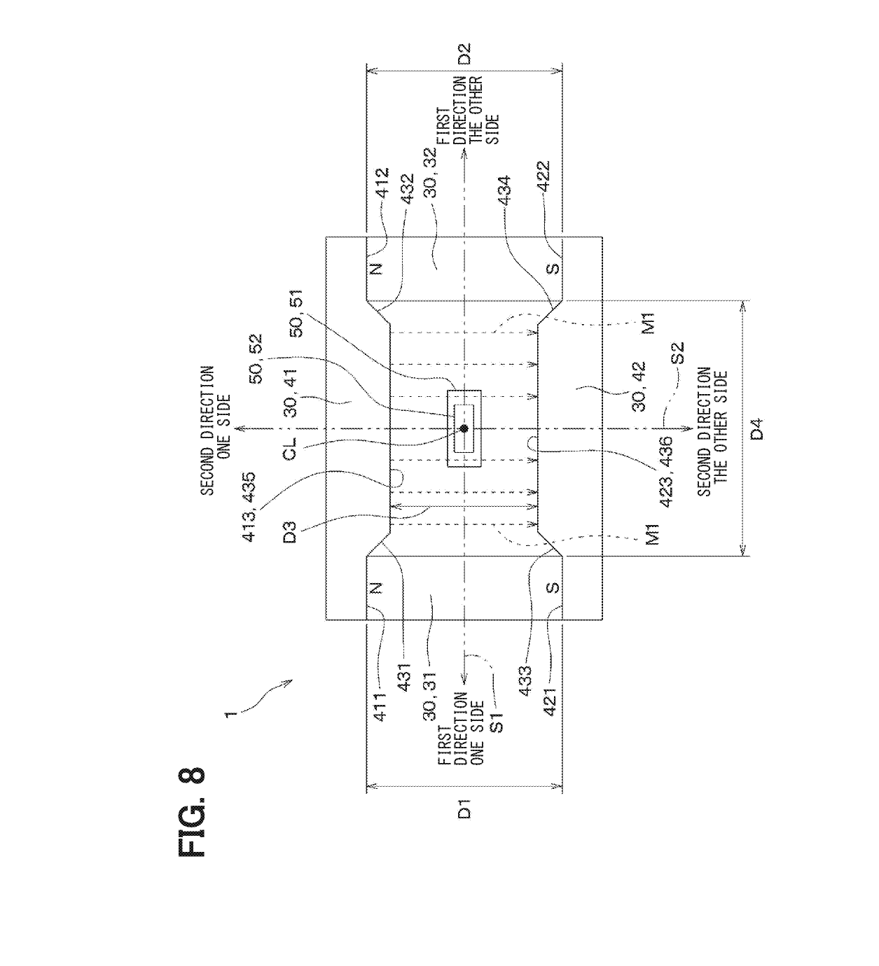

As shown in FIG. 8, in the magnetic circuit 30 provided in the rotation angle detection device 1 of the third embodiment, the first magnet distance D1 and the second magnet distance D2 are both greater than the yoke inner wall distance D3. The first magnet distance D1 and the second magnet distance D2 are the same.

In the third embodiment, the inclined portions 431 to 434 are provided in the portions of the yokes 41 and 42 near the magnets 31 and 32. The inclined portions 431 to 434 are oriented toward the side of the magnet that is nearest to them. Specifically, the first inclined portion 431 provided in the first yoke 41 at a portion near the first magnet 31 faces the first magnet 31 side. The second inclined portion 432 provided in the first yoke 41 at a portion near the second magnet 32 faces the second magnet 32 side. Furthermore, the third inclined portion 433 provided in the second yoke 42 at a portion near the first magnet 31 faces the first magnet 31 side. The fourth inclined portion 434 provided in the portion of the second yoke 42 near the second magnet 32 faces the second magnet 32 side.

The first yoke inner wall surface 413 has a first parallel portion 435 formed between the first inclined portion 431 and the second inclined portion 432 and parallel to the first direction. The second yoke inner wall surface 423 also has a second parallel portion 436 formed between the first inclined portion 431 and the second inclined portion 432 and parallel to the first direction. Both the first parallel portion 435 and the second parallel portion 436 have lengths that are not less than half of the distance D4 between the first magnet 31 and the second magnet 32.

The magnetic circuit 30 of the third embodiment described above is configured so that the magnetic field emitted from the inclined portions 431 to 434 and passing through the inner region of the magnetic circuit 30 does not affect the magnetic field emitted from the first parallel portion 435, passing through the inner region of the magnetic circuit 30, and heading toward the second parallel portion 436. Therefore, the range of the parallel magnetic field can be increased in the the inner region of the magnetic circuit 30 including the axis CL and the vicinity of the axis CL. Therefore, the rotation angle detection device 1 can improve the detection accuracy of the rotation angles of the shaft member 20 and the brake pedal 21 relative to the housing 10.

### Fourth Embodiment:

A fourth embodiment will be described. The fourth embodiment is similar to the first embodiment except for a part of the configuration of the magnetic circuit 30 modified from the corresponding configuration of the first embodiment. Accordingly, only parts different from the corresponding parts of the first and third embodiments are herein described.

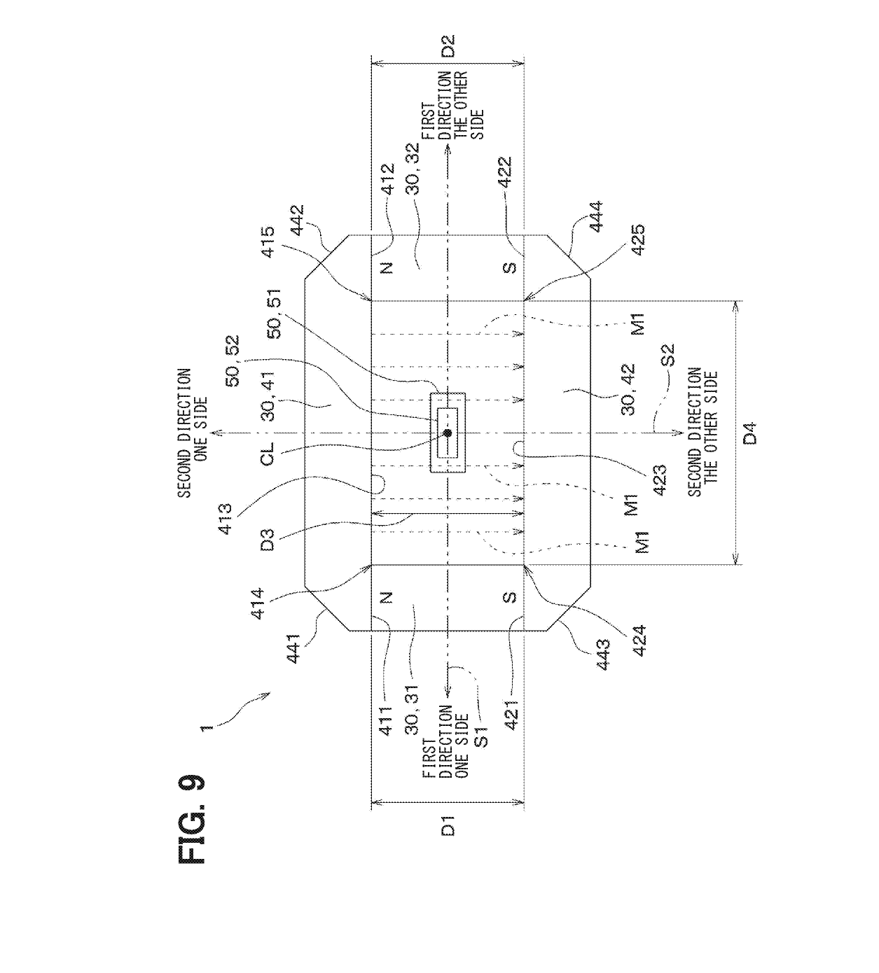

As shown in FIG. 9, the magnetic circuit 30 provided in the rotation angle detection device 1 of the fourth embodiment has the chamfered portions 441 to 444 at each of the four corners of the outer wall of the magnetic circuit 30 when viewed from the direction in which the axis CL extends. In this way, the shape of the outer wall of the magnetic circuit 30 can be changed as desired.

The fourth embodiment described above can also achieve the same effects as the first embodiment.

The shape of the outer wall of the magnetic circuit 30 is not limited to that exemplified in the fourth embodiment, but may be various shapes such as a circle, an ellipse, a polygon, or a combination thereof.

### Other Embodiments:

(1) In the above embodiments, the rotation angle detection device 1 has been described as being used in the brake pedal device 2, but it is not limited to this application and can be used in various products that have a support body and a rotating body, such as an accelerator pedal device or an electronic throttle.

(2) In each of the above embodiments, the brake pedal device 2 has been described as having a configuration in which the shaft member 20 is rotatably mounted relative to the housing 10. However, the present disclosure is not limited to this configuration, and the brake pedal 21 may be rotatably mounted relative to the shaft member 20 fixed to the housing 10. In this case, the rotation angle detection device 1 is configured, for example, so that the magnetic circuit 30 is provided on the brake pedal 21 as a rotating body, and the magnetic detection unit 50 is provided on the housing 10 or the shaft member 20, and detects the rotation angle of the brake pedal 21 relative to the housing 10.

(3) In each of the above embodiments, the inner wall surface of the magnetic circuit 30 is described as being formed in a rectangular shape when viewed from the direction in which the axis CL extends. However, this is not limited to this configuration, and the rectangular shape may also be a shape in which the corners are slightly chamfered.

The present disclosure is not limited to the embodiments described above, and can be modified as appropriate. The above-described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Also, the shape, the positional relationship, and the like of the component or the like mentioned in the above embodiments are not limited to those being mentioned unless otherwise specified, limited to the specific shape, positional relationship, and the like in principle, or the like.

The control unit and the method thereof described in the present disclosure are realized by a dedicated computer provided by configuring a processor and a memory programmed to execute one or more functions embodied by a computer program. May be done. Alternatively, the controller and the method described in the present disclosure may be implemented by a special purpose computer configured as a processor with one or more special purpose hardware logic circuits. Alternatively, the controller and the method described in the present disclosure may be implemented by one or more special purpose computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The memory is a non-transitory tangible storage medium.

What is claimed is:

1. A rotation angle detection device for detecting a rotation angle of a rotating body rotatably provided with respect to a support body comprising:
a magnetic circuit fixed to the rotating body, the magnetic circuit having a first magnet and a second magnet arranged opposite each other across a rotation axis of the rotating body and having a same magnetization direction, and a first yoke and a second yoke connecting same poles of the first magnet and the second magnet; and
a magnetic detection unit having a magnetic detection element configured to output an electric signal according to a magnetic field in an inner region of the magnetic circuit, the magnetic detection element being fixed to the support body so that the magnetic detection element is positioned on an axis, wherein
when a direction in which an imaginary line connecting a center of the first magnet and a center of the second magnet extends is defined as a first direction, and a direction in which the axis extends and which is perpendicular to the first direction is defined as a second direction, the first yoke and the second yoke are disposed opposite to each other in the second direction across the axis, and
a distance between a portion of the first yoke facing a north pole of the first magnet and a portion of the second yoke facing a south pole of the first magnet and a distance between a portion of the first yoke facing a north pole of the second magnet and a portion of a second yoke facing a south pole of the second magnet are both greater than or equal to a distance between a surface of the first yoke facing the second yoke between the first magnet and the second magnet and a surface of the second yoke facing the first yoke between the first magnet and the second magnet.

2. The rotation angle detection device according to claim 1, wherein
the surface of the first yoke facing the second yoke between the first magnet and the second magnet, and the surface of the second yoke facing the first yoke between the first magnet and the second magnet, are both planar and parallel to the first direction.

3. The rotation angle detection device according to claim 1, wherein
the surface of the first yoke facing the second yoke between the first magnet and the second magnet, and the surface of the second yoke facing the first yoke between the first magnet and the second magnet, are both planar and parallel to the first direction, extending between the first magnet and the second magnet.

4. The rotation angle detection device according to claim 1, wherein
both the first yoke and the second yoke are either flat-shaped or rectangular parallelepiped-shaped.

5. The rotation angle detection device according to claim 1, wherein
the magnetic circuit is symmetrical with respect to a predetermined imaginary plane that includes the axis and is parallel to the second direction.

6. The rotation angle detection device according to claim 1, wherein
the magnetic circuit is symmetrical with respect to a predetermined imaginary plane that includes the axis and is parallel to the second direction, and is symmetrical with respect to another imaginary plane that includes the axis and is parallel to the first direction.

7. The rotation angle detection device according to claim 1, wherein
a distance between the first magnet and the second magnet is greater than a distance between the surface of the first yoke facing the second yoke between the first magnet and the second magnet and the surface of the second yoke facing the first yoke between the first magnet and the second magnet.

8. The rotation angle detection device according to claim 1, wherein
both the first magnet and the second magnet are rectangular parallelepiped-shaped.

9. The rotation angle detection device according to claim 1, wherein
both the first magnet and the second magnet are cylindrical-shaped.

10. The rotation angle detection device according to claim 1, wherein
the magnetic detection unit calculates a direction of the magnetic field passing through the magnetic detection element based on a magnitude of a signal output in accordance with the magnetic flux density passing through at least one magnetic sensing surface of the magnetic detection element.

11. The rotation angle detection device according to claim 1, wherein
the magnetic detection unit calculates a direction of the magnetic field passing through the magnetic detection element based on a magnitude of a signal output in response to a magnetic flux density passing through a first magnetic sensing surface of the magnetic detection element and a magnitude of a signal output in response to the magnetic flux density passing through a second magnetic sensing surface (55), which is arranged in a direction different from that of the aforementioned first magnetic sensing surface.

12. The rotation angle detection device according to claim 1, wherein
the magnetic detection element is a Hall element.

13. The rotation angle detection device according to claim 1, wherein
the magnetic detection element is a magnetoresistive effect element.

14. The rotation angle detection device according to claim 1, wherein
the rotation angle detection device is used in a brake pedal device including the support body fixed to a vehicle body, an axial member provided on the support body, and a brake pedal provided on the support body so as to be rotatable within a predetermined angle range around the axis of the axial member, and which detects a rotation angle of the axial member as the rotating body or the brake pedal as the rotating body relative to the support body.

15. A brake pedal device mounted on a vehicle comprising:
a support body fixed to a vehicle body;
a shaft member provided on the support body;
a brake pedal provided rotatably within a predetermined angle range around an axis of the shaft member relative to the support body; and
a rotation angle detection device according to claim 1 configured to detect a rotation angle of the shaft member as the rotating body or the brake pedal as the rotating body relative to the support body.
